(19) United States
(12) Patent Application Publication
(10) Pub. No.: US 2005/0213601 A1
(43) Pub. Date: Sep. 29, 2005

(54) Method and apparatus to provide hidden node protection

(76) Inventors: Boris Ginzburg, Haifa (IL); Rony Ross, Tel-Aviv (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/810,801

(22) Filed: Mar. 29, 2004

(51) Int. Cl. H04Q 7/24

(52) U.S. Cl. 370/443; 370/338

(57) ABSTRACT

Briefly, a method and apparatus that may detect hidden nodes in BSS based on a hidden node report that may be generated in an access point based on nodes reports received from stations of the BSS. The access point may enable and/or disable a hidden node protection mechanism and/or may control the transmit power of the stations.

### BACKGROUND OF THE INVENTION

A wireless local area network (WLAN) may include a basic service set (BSS). The BSS may include an access point (AP) and one or more stations (STA) that may also be referred to as nodes. A hidden node is a known problem of the BSS. The hidden node problem may occur when a signal transmitted from a first station to a second station is not received by the second station. Thus, the second station may attempt to transmit signals which may collide with the signal transmitted by the first station.

For example, the first station may transmit a ready-to-send (RTS) signal to the AP and the AP may reply with a clear-to-send (CTS) signal. The second station may receive only the CTS that was transmitted by the AP and may not be aware of an ongoing transmission between the first station (e.g. the hidden node) and the AP. The second station may attempt to transmit signals to the AP. The attempts to transmit signals by the second station may cause collisions with the signals transmitted by the first station.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a wireless communication system according to an exemplary embodiment of the present invention;

FIG. 2 is a block diagram of a station according to some exemplary embodiments of the present invention;

FIG. 3 is a block diagram of an access point according to exemplary embodiments of the present invention; and

FIG. 4 is a flow diagram that shows flow of protocol command between nodes of a wireless communication system and according to an exemplary method that may be used with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, or transmission devices.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, wireless local area network (WLAN) stations, two-way radio stations, digital system stations, analog system stations, cellular radiotelephone stations, and the like.

Types of WLAN stations intended to be within the scope of the present invention include, although are not limited to, mobile stations, access points, stations for receiving and transmitting spread spectrum signals such as, for example, Frequency Hopping Spread Spectrum (FHSS), Direct Sequence Spread Spectrum (DSSS), Complementary Code Keying (CCK), Orthogonal Frequency-Division Multiplexing (OFDM) and the like.

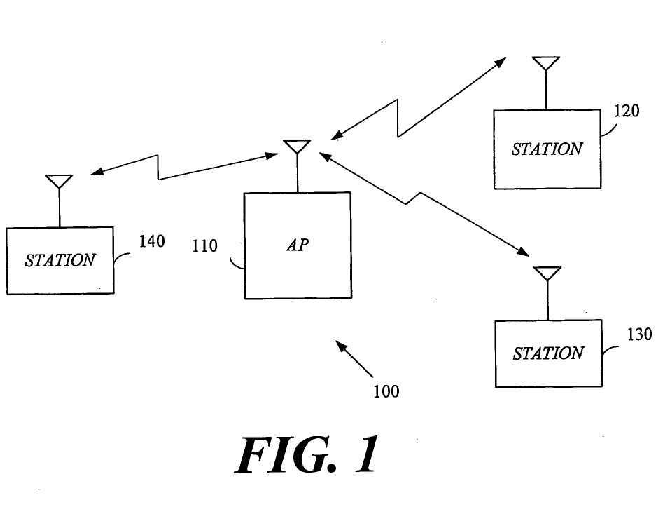

Turning first to FIG. 1, a wireless communication system 100, for example, a WLAN is shown. Although the scope of the present invention is not limited in this respect, the exemplary WLAN 100 may be defined, by IEEE 802.11-1999 standard, as a BSS. For example, the BSS may include at least one communication station, for example, an AP 110, and stations 120, 130 and 140. According to embodiments of the invention, AP 110, stations 120, 130 and 140 may be referred as nodes. According to exemplary embodiments of the invention, one node may be hidden from at least one other node. In some embodiments, stations 120, 130 and 140 may transmit and/or receive one or more packets over WLAN 100. For example, the packets may include data, control messages, network information, and the like. Additionally or alternatively, in other embodiments of the present invention, WLAN 100 may include two or more APs and two or more mobile stations. This arrangement of WLAN 100 may be referred by IEEE 802.11-1999 standard as extended service set (ESS), although the scope of the present invention is not limited in this respect.

Although the scope of the invention is not limited in this respect, in this exemplary embodiment of the invention, transmissions from station 140 may not be received by station 120 and/or station 130. However, transmissions from AP 110 to station 140 may be received by station 120 and/or station 130. Thus, station 140 may be presented as a “hidden node” to at least one other node of wireless communication system 100 (e.g. station 120 and/or station 130), although the scope of the present invention is in no way limited in this respect.

It should be understood that the hidden node problem, and thus the inventive solution described herein, is not limited to a WLAN environment. In particular, embodiments of the invention may well be applied to any wireless network, e.g., one in which cognitive radios or software defined radios practice non-interfering communication within an otherwise restricted communication spectrum.

According to embodiments of the invention, stations (e.g. nodes) of the WLAN 100 may report AP 110 their properties. AP 100 may detect the hidden node (e.g. station 140) by analyzing the reports that received form at least a subset of stations (e.g. stations 120, 130) of WLAN 100, although the scope of the present invention is not limited in this respect.

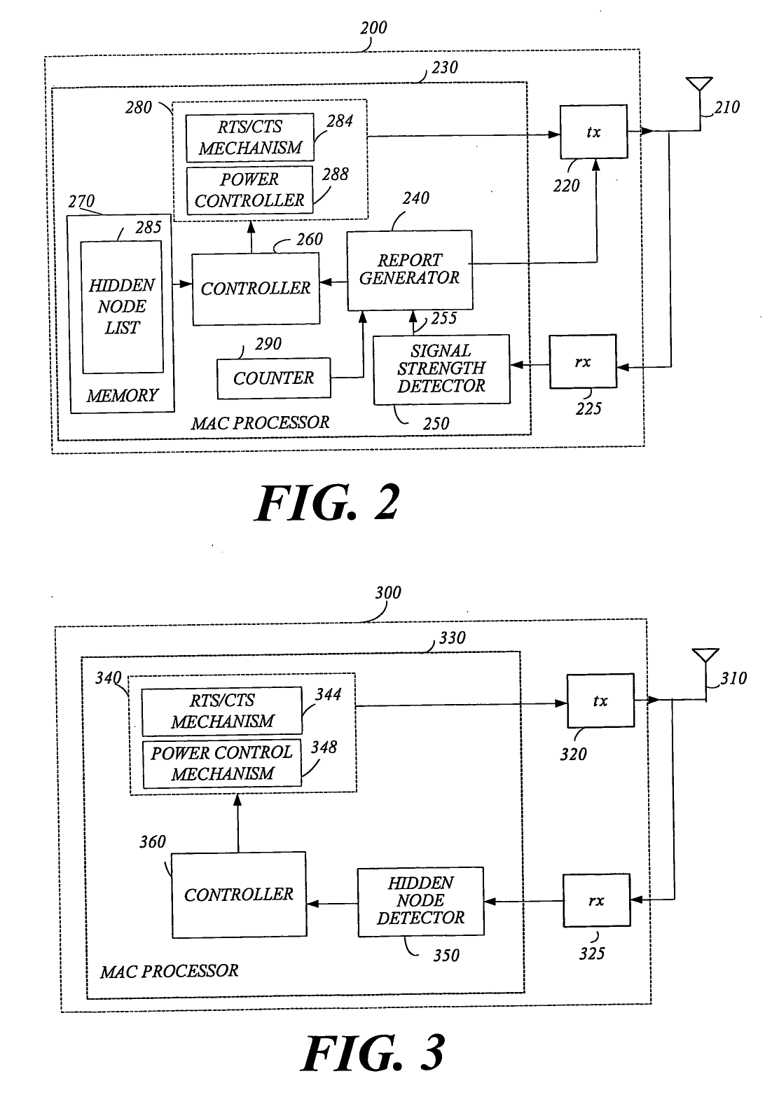

Turning to FIG. 2, a block diagram of a station 200 (e.g. a node) according to exemplary embodiments of the present invention is shown. Although the scope of the present invention is not limited in this respect, station 200 may include an antenna 210, a transmitter (TX) 220, a receiver (RX) 225 and a medium access control (MAC) processor 230. In some embodiments of the invention, MAC processor 230 may include a report generator 240, a signal strength detector 250, a controller 260, a memory 270, a protection mechanism 280 and a counter 290. In some embodiments of the invention protection mechanism 280 may include an RTS/CTS mechanism 284 and/or transmitter (TX) power controller 288.

Although the scope of the present invention is not limited in this respect, antenna 210 may be an omni-directional antenna, a monopole antenna, a dipole antenna, an end fed antenna, a circularly polarized antenna, a micro-strip antenna, a diversity antenna and the like. MAC processor 230 may include a digital signal processor, a communication processor, and the like.

Although the scope of the present invention is not limited in this respect, station 200 may include TX 220 and RX 225 to transmit and receive signals which may include data packets, respectively. In some embodiments of the invention, counter 290 may count the number of data packets that are received from other stations, for example stations 120, 130 and 140. Signal strength detector 250 may measure received signals strength and may provide a value of received signal strength indicator (RSSI) 255 to report generator 240.

Although the scope of the present invention is not limited in this respect, MAC processor 230 may receive a command to send a report to an AP for example, AP 110. Controller 260 may command report generator 240 to generate a report and to send the report to the AP. In embodiments of the invention, the AP may receive reports from subset of WLAN stations and may detect a hidden node based on the WLAN station's reports. The report may include the received station address, received station RSSI and the number of packets received from the station, although the scope of the present invention is not limited to this respect.

If a hidden node may be detected by the AP, the AP may send a command to station 200 to invoke a hidden node protection. For example, controller 260 may command hidden node protection mechanism 280. In some embodiments of the invention hidden node protection may be RTS/CTS mechanism 284. In some other embodiments of the invention the hidden node protection may be provided by power controller 288. For example, power controller 288 may adjust the power level of TX 220 according to a desired level that may be provided by the AP (e.g. AP 110). In some other embodiment of the invention, the hidden node protection may be provided by both RTS/CTS mechanism 284 and power controller 288 or other protection mechanism known in the art. Additionally or alternatively, a station that may be detected as a hidden node (e.g. hidden station) may be stored in a hidden node list at memory 270, if desired.

Turning to FIG. 3 a block diagram of an AP 300 according to some exemplary embodiments of the present invention is shown. Although the scope of the present invention is not limited in this respect, AP 300 may include at least one antenna 310 that may be used to transmit and/or receive data packets over wireless communication system 100 (FIG. 1), for example, WLAN. In embodiments of the invention, antenna 310 may be an omni-directional antenna, a monopole antenna, a dipole antenna, an end fed antenna, a circularly polarized antenna, a microstrip antenna, a diversity antenna and the like.

Although the scope of the present invention is not limited in this respect, AP 300 may include a transmitter (TX) 320, a receiver (RX) 325 and a MAC processor 330. In some embodiments of the invention, MAC processor 330 may include a hidden node protection mechanism 340, a hidden node detector 350, and a controller 360. For example, in some embodiments, hidden node protection mechanism 340 may include a power control mechanism 348 to adjust an output power level of TX 320 according to a reported RSSI and/or an RTS/CTS protection mechanism 344.

Although the scope of the present invention is not limited in this respect, TX 320 may send a request to generate a nodes report to stations of WLAN 100. The stations may generate the nodes report and may send it to AP 300. RX 325 may receive the nodes reports from a subset of stations (e.g. stations 120, 130 and 140) of WLAN 100. It should be understood that the subset of stations may include any desired numbers of stations from a single station up to all the stations of WLAN 100.

Although the scope of the present invention is not limited in this respect, hidden node detector 350 may detect the hidden node from analyzing the nodes reports received from the subset of stations. For example, hidden node detector 350 may detect the addresses of stations of WLAN 100. In addition, hidden node detector 350 may detect a hidden node from analyzing a value of RSSI of other stations measured by the reporting station. According to embodiments of the invention, a low RSSI value may indicate a hidden node. In some embodiments of the invention, hidden node detector 350 may detect a hidden node by a detection of an unreported station (e.g. node) and at least one of the nodes reports.

Additionally or alternatively, hidden nodes detector 350 may detect a hidden node from analyzing the value of received packets from one station as measured by the reporting station. A low value, for example 1, 2 . . . 5, may indicate a hidden node. In some embodiments of the invention, hidden node detector 350 may detect a hidden node based on the RSSI value and the number of received packets. For example, a law value of RSSI and a low number of received packets, although the scope of the present invention is not limited in this respect.

In embodiments of the invention, if hidden node detector 350 detects a hidden node, controller 360 may activate a hidden node protection mechanism 340 to protect from transmissions of the hidden node. For example, hidden node protection mechanism 340 may activate a RTS\CTS control mechanism such as, for example RTS\CTS control mechanism 344, in the corresponding station and/or may activate a power control mechanism 348 to eliminate hidden node. For example, power control mechanism 348 may include a subset of desired transmitted power levels related to the subset of stations and may send a desired Tx power level to stations of the WLAN 100. For example, the desired Tx power level of a hidden node (e.g. a station) may be the maximum available power of the station, for example 17 dBm, and for the other stations the desired power level may be a power level that may not block the hidden node (e.g. station), for example, 4 dBm, although the scope of the present invention is not limited in this respect.

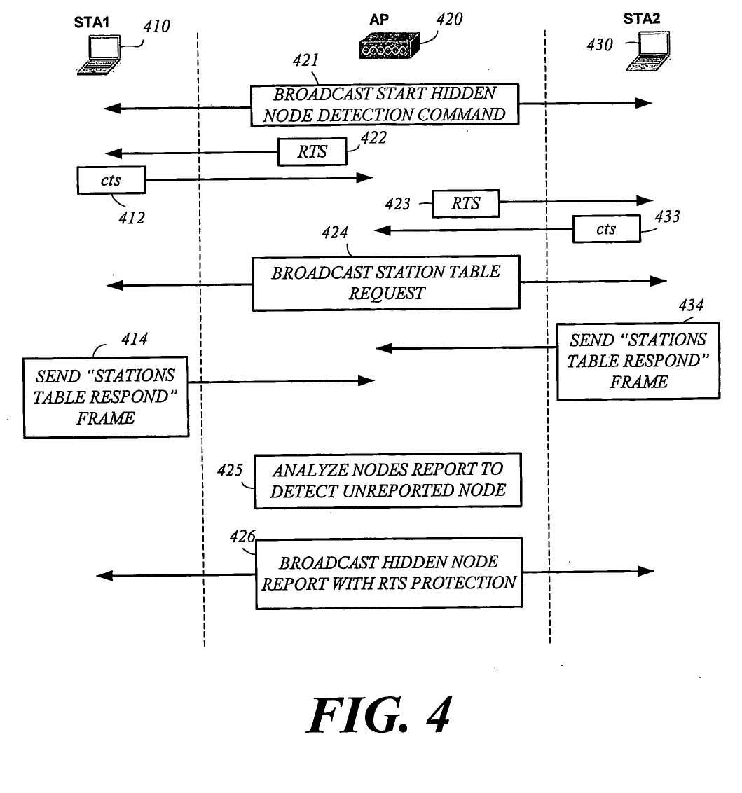

Turning to FIG. 4 an illustration of a protocol flow commands between an AP 420 to stations 410, 430 (e.g. STA1 and STA2) according to exemplary embodiments of the present invention is shown. Although the scope of the present invention is not limited in this respect, AP 420 may broadcast (e.g. to STA1 410 and STA2 430) to start hidden node detection (block 421). For example, AP 420 may broadcast a management frame “Start of Hidden Node Detection” to cause STA1 410 and STA2 420 to be awake until the detection of hidden nodes may be completed. In addition, “Start of Hidden Node Detection” frame may notify the stations of the BSS (e.g. STA1 410, STA2 420) when the testing period may start. This information may be also embedded into a beacon, if desired. In response, STA1 410 and STA2 430 may generate nodes reports. In addition, during testing period STA1 410 and STA2 420 may stay awake to collect information on how many packets were received from other stations belonging to the BSS.

Although the scope of the present invention is not limited in this respect, AP 430 may collect information from active stations of the network (e.g. STA1 410 and STA2 430). For example, AP 420 may send RTS frame 422 to STA1 410 and STA1 410 may respond by sending CTS frame 412. In a similar way, AP 430 may collect information from STA1 410 and STA2 430. For example, AP 420 may send RTS frame 423 to STA2 430 and STA2 430 may respond by sending CTS frame 433, although the scope of the present invention is not limited in this respect.

Although the scope of the present invention is not limited in this respect, AP 420 may send a broadcast request such as, for example “Stations Table Request” frame, to active stations such as, for example, STA1 410, STA2 430, to send the nodes report (block 424). STA1 410 and STA2 430 may respond by sending “Stations Table Response” frame to AP 420 as is shown in block 414 and block 434, respectively. According to some embodiments of the invention, “Stations Table Response” frame may include the nodes report which may include a table of nodes that include a received signal strength indicator for subset of node, if desired. In some embodiments of the invention, in the case that AP 420 may not receive the “Stations Table Response” from at least one station e.g STA1 410, AP 420 may resend a “Stations Table Request” frame to this station, if desired.

Although the scope of the present invention is not limited in this respect, AP 420 may analyze the nodes report and may detect hidden nodes. For example, the detection may be done by detecting unreported nodes (block 425). For example, the nodes reports of STA1 410 may indicate that STA2 430 is unreported.

Although the scope of the present invention is not limited in this respect, in the case that AP 420 may detect hidden node, AP 420 may send to the stations (e.g STA1, STA2) a report on the detected hidden nodes and may activate RTS protection mechanism (block 426). For example, AP 420 may decide which one of the stations may need hidden node protection such as, for example RTS protection mechanism, and may activate the hidden node protection mechanism on this station.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method comprising:
detecting a hidden node in a wireless communication system by analyzing a nodes report received from a subset of nodes.

2. The method of claim 1 comprising:
sending a request to generate the nodes report.

3. The method of claim 1, wherein analyzing comprises:
detecting an unreported node; and
activating a hidden node protection on a reporting node.

4. The method of claim 1, wherein analyzing comprises:
detecting a signal strength below or equal to a threshold; and
activating a hidden node protection mechanism on a reporting node.

5. The method of claim 3, wherein activating a hidden node protection mechanism comprises:
enabling a request-to-send\clear-to-send (RTS\CTS) control mechanism.

6. The method of claim 3, wherein activating a hidden node protection mechanism comprises:
sending a subset of power adjustment commands to a subset of nodes based on the nodes report.

7. The method of claim 4, wherein activating a hidden node protection mechanism comprises:
enabling a request-to-send\clear-to-send (RTS\CTS) control mechanism.

8. The method of claim 4, wherein activating a hidden node protection mechanism comprises:
sending a subset of power adjustment commands to a subset of nodes based on the nodes report.

9. The method of claim 1, further comprising:
generating a hidden nodes list based on reports received from the subset of nodes.

10. The method of claim 9, comprising:
marking a node on the hidden nodes list as a hidden node; and
activating a hidden node protection mechanism on the marked nodes.

11. A method comprising:
activating a hidden node protection mechanism based on a received nodes report.

12. The method of claim 11, comprising:
receiving a request to generate a nodes report.

13. The method of claim 12, wherein generating the nodes report comprises:
generating a table of nodes that includes a received signal strength indicator for subset of node.

14. The method of claim 11, wherein activating a hidden node protection mechanism comprises:
enabling a request-to-send\clear-to-send (RTS\CTS) control mechanism.

15. The method of claim 11, wherein activating a hidden node protection mechanism comprises:
adjusting a transmitted power level.

16. An apparatus comprising:
a hidden node detector to detect a hidden node in a wireless communication system based on a nodes report generated from a received nodes report received from a subset of nodes.

17. The apparatus of claim 16, comprising:
a transmitter to send a request to generate the received nodes report.

18. The apparatus of claim 16, comprising:
a controller to activate a hidden node protection mechanism.

19. The apparatus of claim 16, wherein the hidden node detector is able to detect a hidden node by analyzing a reported signal strength indicator of a node at the nodes report.

20. The apparatus of claim 16, wherein the hidden node detector is able to detect a hidden node by detection of an unreported node at the nodes report.

21. The apparatus of claim 20, wherein the hidden node protection mechanism comprises a request-to-send\clear-to-send (RTS\CTS) control mechanism.

22. The apparatus of claim 20, wherein the hidden node protection mechanism comprises a transmitted power control mechanism that includes a subset of desired transmitted power levels related to the subset of nodes.

23. An apparatus comprising:
a controller to activate a hidden node protection mechanism based on nodes report.

24. The apparatus of claim 23, comprising:
a nodes report generator to generate the nodes report.

25. The apparatus of claim 24, wherein nodes report generator is able to generate the node report that comprises a table that includes at least a received signal strength indicator for subset of node.

26. The apparatus of claim 23, wherein the hidden node protection mechanism comprises a request to send\clear to send (RTS\CTS) control mechanism.

27. The apparatus of claim 23, wherein a hidden node protection mechanism comprises a power controller to adjust a power level of a transmitter according to a received power level.

28. A wireless communication system comprising:
a station to generate a nodes report of nodes of the wireless communication system; and
an access point to detect a hidden node by analyzing properties of the nodes report.

29. The wireless communication system of claim 28, wherein the access point is able to activate a hidden node protection mechanism to protect the station from transmissions of the hidden node.

30. The wireless communication system of claim 28, wherein the access point is able to detect a hidden node by analyzing a reported signal strength indicator of a node at the nodes report.

31. The wireless communication system of claim 28, wherein the access point is able is able to detect a hidden node by detection of an unreported node at the nodes report.

32. The wireless communication system of claim 29, wherein the hidden node protection mechanism comprises a request-to-send\clear-to-send (RTS\CTS) control mechanism.

33. The wireless communication system of claim 28, wherein the hidden node protection mechanism comprises a transmitted power control mechanism that includes a subset of desired transmitted power levels related to the subset of nodes.

34. An apparatus comprising:
a dipole antenna to receive a hidden node protection command; and
a controller to activate a hidden node protection mechanism based on the hidden node protection command.

35. The apparatus of claim 34, comprising:
a nodes report generator to generate a nodes report.

36. The apparatus of claim 35, wherein nodes report generator is able to generate the node report that comprises a table that includes at least a received signal strength indicator for subset of node.

37. The apparatus of claim 34, wherein the hidden node protection mechanism comprises a request to send\clear to send (RTS\CTS) control mechanism.

38. The apparatus of claim 34, wherein a hidden node protection mechanism comprises a power controller to adjust a power level of a transmitter according to a received power level.

39. An article comprising:
a storage medium, having stored thereon instructions, that when executed, result in:
detecting a hidden node at a wireless communication system by analyzing a nodes report received from a subset of nodes.

40. The article of claim 39 wherein the instructions when executed, result in:
sending a request to generate the nodes report.

41. The article of claim 39 wherein the instructions when executed, result in:
detecting an unreported node; and
activating a hidden node protection on a reporting node.

42. The article of claim 39 wherein the instructions when executed, result in:
detecting a signal strength below or equal to a threshold; and
activating a hidden node protection mechanism on a reporting node.
